(19) United States
(12) Patent Application Publication
(10) Pub. No.: US 2019/0063986 A1
(43) Pub. Date: Feb. 28, 2019

(54) FLOAT INDICATOR DEVICE AND METHOD

(71) Applicant: Jayne Michele TSE, Calgary (CA)

(72) Inventor: Jayne Michele TSE, Calgary (CA)

(21) Appl. No.: 16/109,098

(22) Filed: Aug. 22, 2018

Related U.S. Application Data
(60) Provisional application No. 62/549,218, filed on Aug. 23, 2017.

(51) Int. Cl. G01F 23/76; G01F 23/00; G01F 23/64

(52) U.S. Cl. CPC G01F 23/76; G01F 23/02; G01F 23/64; G01F 23/0038

(57) ABSTRACT

A float product and method of use. A float is described comprising an elongated body having first and second end sections extending between and connecting a weighted section at the first end and a bulb section at the second end. The float is particularly adapted for use in a jug, such as a growler, during filling to help prevent overflow and spillage. Methods of using the float product are also described. The float can be mounted to the jug by way of a ring clip which slides over the neck of the jug.

### CROSS-REFERENCE TO RELATED APPLICATIONS

The instant application is a US non-provisional Application claiming the benefit of U.S. provisional application No. 62/549,218 filed on Aug. 23, 2017, the disclosure of which is hereby expressly incorporated by reference thereto in its entirety.

### BACKGROUND OF THE INVENTION

### 1. Field of the Invention

The field of art to which this invention generally pertains to a float devices such as are used in, e.g., breweries, as well as a method of making and using the same.

### 2. Discussion of Background Information

A growler is a jug used to transport draft beer, and is typically made of glass, ceramic, or stainless steel. They are commonly sold at breweries and brewpubs as a way to transport craft beer. Attendants at growler stations need to see when vessels/containers are nearing full capacity to shut off the tap and decrease overflow and spillage in their facility. There is an increasing number of opaque growlers on the market and they can be turned away at growler fill stations because of the difficulty in filling them due to their opacity.

Accordingly, there is a need for a way to better fill opaque growlers in a more efficient manner.

### SUMMARY OF THE INVENTION

A float is described including an elongated body having first and second end sections extending between and connecting a weighted section at the first end and a bulb section at the second end, where the float is particularly adapted for use in a jug during filling to help prevent overflow and spillage.

Additional embodiments include: the float described above where the jug is a growler; the float described above where the bulb section is particularly adapted for insertion into, and removable connection with, a mount section; the float described above where the mount section is removably attached to the jug; the float described above removably connected to a mount; the float described above including a polymer coating of food-safe polymer on the entirety of the float; the float described above including a fill-indicating gradient band on at least a portion of the float just below the bulb section of the float.

A method of filling a growler is also described including dropping the float into the growler before, or prior to completion of, the filling process; beginning or continuing the growler filling process; stopping the filling process when at least a portion of the body appears above the top of the growler; where the filling process results in elimination of, or reduced, filling overflow and spillage.

According to another non-limiting example, the invention is a float capable of floating in drinkable liquid inside a jug, comprising an elongated body having first and second ends, a weighted section located at the first end, and a bulb section located at the second end. The float is sized and configured to be positionable inside a jug during filling to help prevent overflow and spillage during filling.

In embodiments, the jug is a growler.

In embodiments, the bulb section is removably connectable to mounting device mounted to a neck of the jug.

In embodiments, the mounting device has a ring portion and a float mount section.

In embodiments, the weighted section is located below a hollow section of the float.

In embodiments, the float may further comprise a polymer coating of food-safe polymer covering an entirety of the float.

In embodiments, the float may further comprise a fill-indicating marker section arranged on at least a portion of the float below the bulb section.

In embodiments, there is provided a method of filling a growler while eliminating or reducing filling overflow and spillage, comprising dropping the float of claim 1 into the growler before, or prior to completion of, the filling process and stopping the filling process when at least a portion of the float appears above a top of the growler.

In embodiments, there is provided a float capable of floating in beer during filling of a jug with the beer, comprising an elongated body having first and second ends and an overall length that is between 6 and 18 inches, a low-density section disposed between the first and second ends, a high-density section having higher density than the low-density section and being located at the first end, an enlarged section located at the second end, and a visual indicator section located closer to the enlarged section than to the first end. The float is positionable inside a jug during filling to help prevent overflow and spillage of beer during filling of the jug.

In embodiments, the low-density section comprises a cylindrical wall surrounding a hollow section.

In embodiments, an axial length of the low-density section is between three and twenty-two times the axial length of the high-density section.

In embodiments, there is provided a float capable of floating in beer during filling of a jug with the beer, comprising an elongated body having first and second ends, a low-density disposed between the first and second ends, a section having higher density than the low-density section and being located at the first end, a bulb section located at the second end, a visual indicator section located closer to the bulb section than to the first end, said visual indicator having both an almost-full visual indicator and a full visual indicator, and an externally located food-grade coating, wherein the float is positionable inside a jug during filling to help prevent overflow and spillage of beer during filling of the jug.

These and additional embodiments are further described below.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a cross-section view of a float embodiment as described herein;

FIG. 2 shows a float embodiment as described herein attached to a jug via a clip;

FIGS. 3a, 3b and 3c show how a float can be used during filling of a jug; and

FIG. 4 shows another exemplary float embodiment.

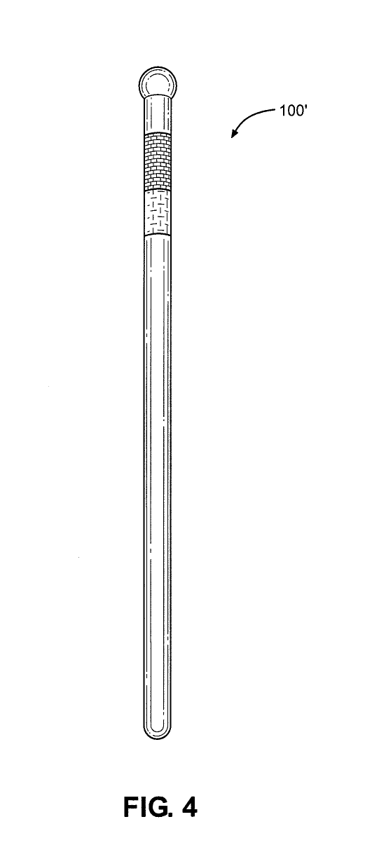

### DETAILED DESCRIPTION OF THE INVENTION

The particulars shown herein are by way of example and for purposes of illustrative discussion of the various embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description making apparent to those skilled in the art how the several forms of the invention may be embodied in practice.

The present invention will now be described by reference to more detailed embodiments. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are expressly incorporated by reference in their entirety.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Every numerical range given throughout this specification will include every narrower numerical range that falls within such broader numerical range, as if such narrower numerical ranges were all expressly written herein.

Additional advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

The floats as described herein contain an body designed to stay upright in a growler vessel during filling. It is used as a filling indicator on various sizes and shapes of growler vessels that have varying levels of opacity. The thinness of the device, the design of the unit, and the weighted bottom help pass or navigate the body through the neck of the vessel without getting stuck inside the vessel during filling therefore making the device an ideal fill indicator for most if not all growler vessels.

The float can reduce overflow and spillage and wasted product at retail growler fill stations and in brewpubs and tap rooms offering growler fills. The float can provide a solution to a problem on at least two fronts: allowing opaque growlers to be filled and to reduce overall spillage/waste at growler fill stations. It can also produce the same results in jugs generally.

### NON-LIMITING EXAMPLE

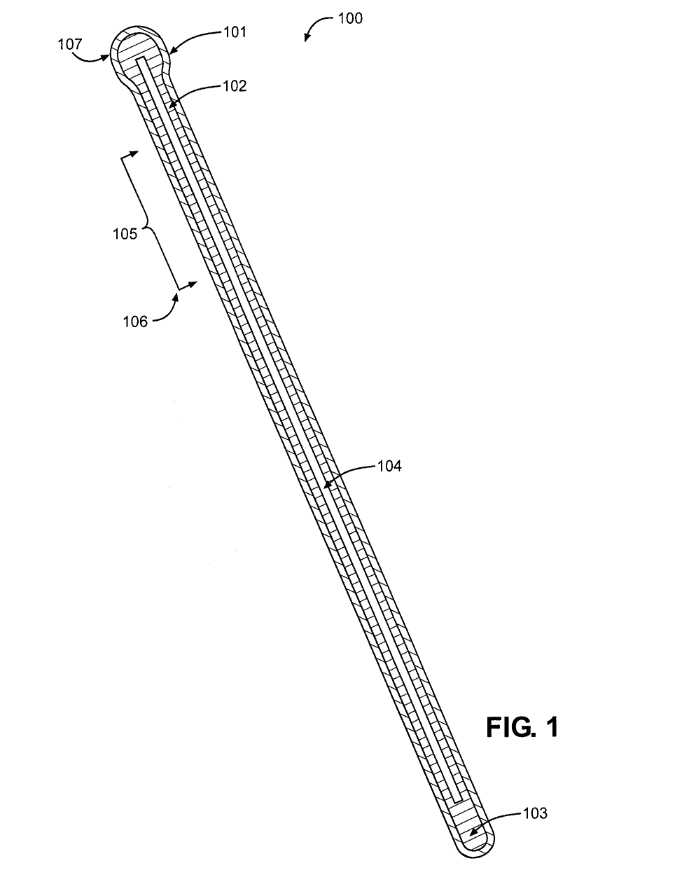

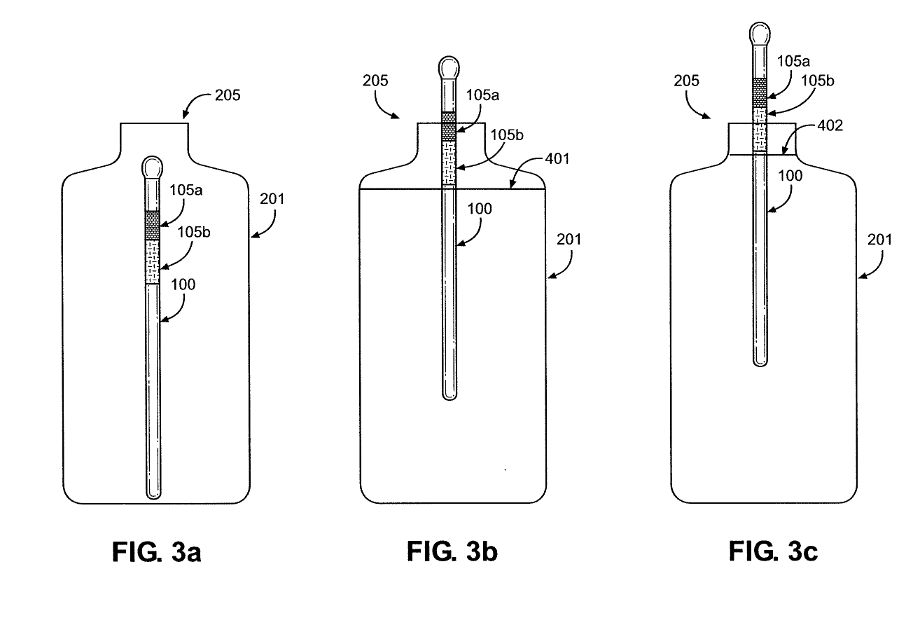

A non-limiting embodiment of the float described herein is a small lightweight device designed to fit or be placed inside a growler while it is being filled. FIG. 1 shows a cross-section representation of the float device 100 includes a cylindrical wall 102 surrounding a hollow section 104 as well as an enlarged section that can be rounder, bulb-shaped and/or a ball-shaped portion 101 for connecting to a jug holder clip (described below). The device 100 also includes a weighted floater section 103 which can have an overall axial length of about ½ inch. Also shown is an externally visible gradient marker or indicator 105 which provides a visual signal or indicator of when the jug is nearly full. In embodiments, this marker 105 can include a first colored section, e.g., a yellow section, to indicate that a fluid level is getting near the top of the vessel, followed by a second colored section, e.g., red section, to indicate a sufficient fill level in which one can stop filling. The axial lengths of each section of the marker 105 can be about 1 inch with the overall axial length of the marker being about 2 inches. The marker 105 can be located, for example, about 7.5 inches from the weighted end 103. The radius of the end 103 can be about 3/16 inches and the radius of the end 101 can be about ¼ inches for a diameter of about ½ inch. The device 100 can be designed to have an overall height of about 11.25 inches, for example, and an outside diameter (without coating) of about ⅜ inch, for example, to permit easy insertion into the mouth of the jug (even with the presence of a beer filling hose in the mouth of the jug, for example). It can be made of several components and include a food-grade silicon outer coating 107, and any conventional-plastic inner portion 102, such as PMMA (poly (methyl methacrylate)) material, for example. The hollow section 104 and the weighted section 103 are such that the upper section of the float 100 is able to float at or near the surface of a fluid such as beer. The density of the float material 103 can typically be about 1.13 to 1.18 grams/cubic centimeter (g/cm³). The wall thickness of the wall 102 around the hollow section 104 can be about 1/16 inch thick with the hollow section having a diameter of about ¼ inch. The hollow section 104 runs basically along an entire length of the float 100, excluding the solid weighted section 103 at the bottom. The total weight of the float 100 will typically be about 11 to about 13 grams. The combination of the total weight, the density, and the weighted end 103, are all designed to allow the float 100 to float at or near the surface of a fluid such a beer at a point just at or below the beginning of the low end 106 of the gradient marker 105. See FIGS. 3b and 3c.

The coating 107 can entirely cover the device 100 and can be any typical food grade polymer, such as for example silicone (for example, SORTA-CLEAR® 37 rubber, from Smooth-On, Inc.) or food grade epoxy, and is typically applied by simply dipping or brushing and air drying the coating. Additional examples for the float materials include MAX CLR 48 oz-Epoxy Resin Food Safe FDA usable as a compliant high impact coating and described in link: https://theepoxyexperts.com/shop/adhesives/max-clr-48-oz-epoxy-resin-food-safe-fda-compliant-clear-high-impact-coating/.

An example of food grade silicone that can be used to make the float or to coat the float includes a material manufactured: Bercen food grade silicones and Bercen EcoArmour RC coating described via link: http://bercen.com/bercens-food-safe-ecoarmour-rc-coating-functional-silicone-alternative/. The coating can be any thickness, but can typically be about 1/16 inch thick or less.

The shape of and overall density of the device 100 allows for movement of the device 100 as it rises in the narrowing top of the vessel being filled. This movement helps guide the device 100 along the side of the vessel wall and navigate through to the neck/opening of the vessel (see FIGS. 3a-3c). The weighted bottom 103 facilitates an upright position as the device 100 swirls within the vessel during filling and allows the device 100 to remain as the highest point and navigate around fill tubes, taps, and vessel walls. The long nature of the device 100 pops out of the neck of the vessel as it reaches fill capacity (see FIGS. 3b and 3c), and is intended as an early indicator for the attendant to turn down the fill speed and shut the tap off before spillage occurs.

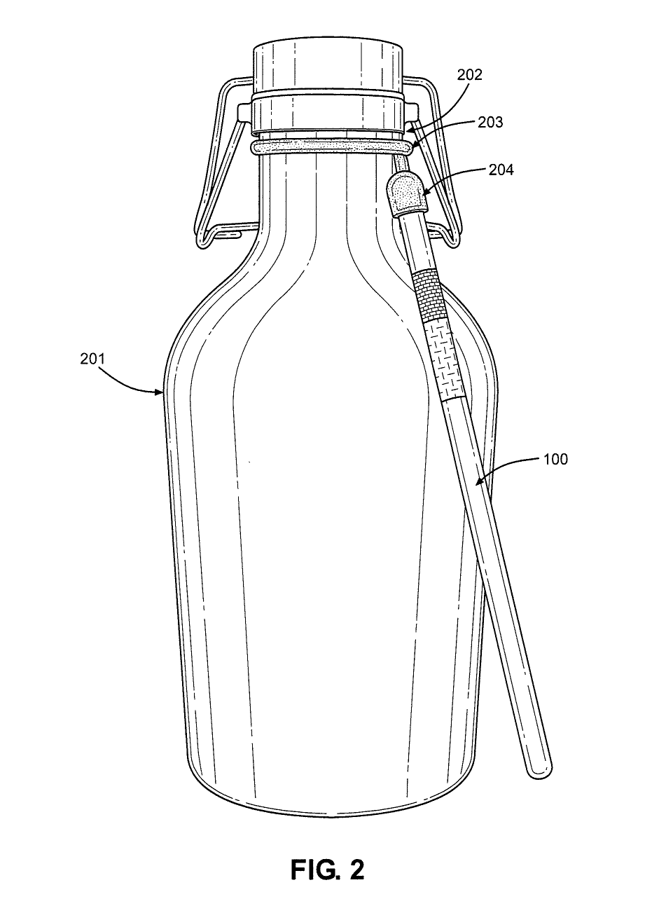

FIG. 2 shows a corresponding mount designed for easy attachment, transport, and removal on personal growler vessels 201. The mount includes a generally flexible (silicone, for example) ring 203 for attachment to the neck 202 of a vessel 201 and an attachment portion 204 whose opening is receive by insertion (via a friction connection) the small, roughly ball or bulbous portion 101, for example) on the top of the device 100 in order to attach the float 100 to the mount. The ball portion 101 can be readily inserted and detached from the mount for easy transport, cleaning, etc. of the float 100. While the mount can be designed to be permanently attached to the growler, it is more often designed to be removable from the neck 202 of the growler 201, e.g., for use with multiple growlers, for cleaning, etc.

FIGS. 3a-3c shows the float embodiment 100 described herein in use. The float 100 containing yellow 105a and red 105b markings is placed in a container 201, e.g., jug or growler. As the level of liquid 401, e.g., beer, rises in the container 201, the yellow marker 105a first appears above the top 205 of the container 201 indicating the container 201 is close to being filled. When the container 201 is full or reaches a full fill level 402, the red indicator marking 105b appears above the top 205 of the container 201 indicating the filling activity should be stopped.

Other non-limiting aspects and embodiments include one, more or all of those embodiments disclosed in U.S. Design application Ser. No. 29/614,828 filed on Aug. 23, 2017 entitled Float Indicator Device, the disclosure of which is hereby expressly incorporated by reference thereto in its entirety. For example, any of the herein disclosed embodiments may utilize one or more features utilized in any one or more of the embodiments of U.S. Design application Ser. No. 29/614,828.

Thus, the scope of the invention shall include all modifications and variations that may fall within the scope of the attached claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A float capable of floating in drinkable liquid inside a jug, comprising:
an elongated body having first and second ends;
a weighted section located at the first end; and
a bulb section located at the second end,
wherein the float is sized and configured to be positionable inside a jug during filling to help prevent overflow and spillage during filling.

2. The float of claim 1, wherein the jug is a growler.

3. The float of claim 1, wherein the bulb section is removably connectable to mounting device mounted to a neck of the jug.

4. The float of claim 3, wherein the mounting device has a ring portion and a float mount section.

5. The float of claim 1, wherein the weighted section is located below a hollow section of the float.

6. The float of claim 1, further comprising a polymer coating of food-safe polymer covering an entirety of the float.

7. The float of claim 1, further comprising a fill-indicating marker section arranged on at least a portion of the float below the bulb section.

8. A method of filling a growler while eliminating or reducing filling overflow and spillage, comprising:
dropping the float of claim 1 into the growler before, or prior to completion of, the filling process; and
stopping the filling process when at least a portion of the float appears above a top of the growler.

9. A float capable of floating in beer during filling of a jug with the beer, comprising:
an elongated body having first and second ends and an overall length that is between 6 and 18 inches;
a low-density section disposed between the first and second ends;
a high-density section having higher density than the low-density section and being located at the first end;
an enlarged section located at the second end;
a visual indicator section located closer to the enlarged section than to the first end,
wherein the float is positionable inside a jug during filling to help prevent overflow and spillage of beer during filling of the jug.

10. The float of claim 9, wherein the low-density section comprises a cylindrical wall surrounding a hollow section.

11. The float of claim 9, wherein an axial length of the low-density section is between three and twenty-two times the axial length of the high-density section.

12. A float capable of floating in beer during filling of a jug with the beer, comprising:
an elongated body having first and second ends;
a low-density disposed between the first and second ends;
a section having higher density than the low-density section and being located at the first end;
a bulb section located at the second end;
a visual indicator section located closer to the bulb section than to the first end, said visual indicator having both an almost-full visual indicator and a full visual indicator; and
an external food-grade coating,
wherein the float is positionable inside a jug during filling to help prevent overflow and spillage of beer during filling of the jug.

13. The float of claim 12, wherein the jug is a growler.
